(19) United States
(12) Patent Application Publication
(10) Pub. No.: US 2025/0018449 A1
(43) Pub. Date: Jan. 16, 2025

(54) APPARATUSES FOR SUPPLYING CLEANING LIQUID AND SILICON WAFER CLEANING MACHINES INCLUDING THE SAME

(71) Applicant: TCL ZHONGHUAN RENEWABLE ENERGY TECHNOLOGY CO., LTD., Tianjin (CN)

(72) Inventors: Lihui JIN, Tianjin (CN); Hua YANG, Tianjin (CN); Zhigao REN, Tianjin (CN); Huan WANG, Tianjin (CN); Chuanling AI, Tianjin (CN); Dawei WANG, Tianjin (CN); Zhijun WU, Tianjin (CN); Hongxia CEN, Tianjin (CN); Chen WEI, Tianjin (CN)

(73) Assignee: TCL ZHONGHUAN RENEWABLE ENERGY TECHNOLOGY CO., LTD., Tianjin (CN)

(21) Appl. No.: 18/548,082

(22) PCT Filed: Jul. 31, 2023
(86) PCT No.: PCT/CN2023/110433

§ 371 Date: Aug. 26, 2023

(30) Foreign Application Priority Data
Jun. 9, 2022 (CN) 202221431071.3

(51) Int. Cl. B08B 13/00; B08B 3/04

(52) U.S. Cl. CPC B08B 13/00; B08B 3/04

(57) ABSTRACT

An apparatus for supplying cleaning liquid may include: a stock solution unit configured with a plurality of stock solution tanks; a cleaning unit configured with a plurality of cleaning tanks; and a transfer unit disposed between the stock solution unit and the cleaning unit. The transfer unit is configured with a plurality of independent transfer tanks. Each of the stock solution tanks communicates with at least one of the transfer tanks, each of the transfer tanks communicates with one of the cleaning tanks, and each of the cleaning tanks communicates with at least one of the transfer tanks.

### CROSS-REFERENCE TO RELATED APPLICATION

The present disclosure claims priority to and the benefit of Chinese Patent Application No. 202221431071.3, filed on Jun. 9, 2022, the disclosure of which is incorporated herein by reference in its entirety.

### TECHNICAL FIELD

The present disclosure relates to silicon wafer processing equipment, and in particular, to apparatuses for supplying cleaning liquid and silicon wafer cleaning machines including the same.

### BACKGROUND

Cleaning of silicon wafers directly affect surface quality of the silicon wafers, and a necessary element to ensure the cleaning quality is a cleaning liquid. Cleaning liquids with different functions are required for cleaning. Accordingly, each kind of cleaning liquid corresponds to a cleaning tank. With the increase of the number of cleaned silicon wafers, solute of the cleaning liquid in the tank is diluted. In order to ensure the concentration standard of each component of the cleaning liquid in the cleaning tank, it is necessary to continuously introduce cleaning liquid into the cleaning tank.

The existing method commonly used for replenishing liquid is a manual liquid replenishing method, that is, adding a stock liquid of a component to the cleaning tank by a worker after a certain number of silicon wafers are cleaned. However, for this manual liquid replenishing method, not only the dosage is difficult to control, but also the timeliness is worse. Meanwhile, for a cleaning liquid with corrosion function, the manual liquid replenishing method has a great influence on people's health and seriously pollutes surrounding environment.

With the advancement of automation, the existing method has been modified to inject liquid directly into the cleaning tank from a stock solution barrel, that is, injecting a prepared cleaning liquid directly into each of the cleaning tanks through a hose. A large quantity of stock solutions are required by a cleaning machine, each kind of stock solution needed is at least about 1 ton to 3 tons, and each cleaning machine needs at least 3 to 4 kinds of stock solutions. The stock solutions have a large cardinality of storage, while areas in a workshop are limited. Further, a chemical solution has a strong irritating smell and cannot be directly disposed beside the cleaning machine. If it is disposed in an outer area of the workshop, it is necessary to provide a long infusion line to connect with the cleaning machine, but this setting mode not only results in a complex line settings, but long-distance pipelines are not easy to maintain, and transmission air pressure is extremely unstable. For each cleaning tank in the cleaning machine, liquid replenishing is intermittent, and the liquid output from the pipelines with unstable air pressure cannot be quickly and accurately injected into the cleaning tank, resulting in poor consistency of liquid concentration in the cleaning tank, which significantly affects the cleaning effect.

### SUMMARY

In view of the above, an embodiment of the present disclosure provides an apparatus for supplying cleaning liquid, which includes: a stock solution unit configured with a plurality of stock solution tanks; a cleaning unit configured with a plurality of cleaning tanks; and a transfer unit disposed between the stock solution unit and the cleaning unit, and the transfer unit is configured with a plurality of independent transfer tanks; wherein each of the transfer tanks communicates with at least one of the transfer tanks, each of the transfer tanks communicates with one of the cleaning tanks, and each of the cleaning tanks communicates with at least one of the transfer tanks. Both the stock solution tank and the transfer tank are used for containing solute of a medicinal solution. Each stock solution tank is connected with a plurality of transfer tanks, and each transfer tank is connected with only one cleaning tank, so as to ensure that the solute of the medicinal solution required in each cleaning tank can be input from an independent transfer tank, and the storage capacity and the output dose of the corresponding transfer tank can be set based on the characteristics of each cleaning tank, which not only achieves easily controlling of the dosage, but also has high timeliness. Further, poor consistency of the concentration of medicinal solution in the cleaning tank due to unstable air pressure in transmission pipelines caused by direct communication between the cleaning tank and the stock solution tank can be improved. Accurate and stable replenishing liquid can be achieved, the pipelines are streamlined and simple, the maintenance and installation are easy, the liquid is ready-to-use and new, and the timeliness is higher.

Optionally, all the transfer tanks communicating with a same cleaning tank are disposed adjacent to each other, so that the structure is simple, and it is convenient to maintain and identify. The pipelines are simplified. Consumption of other adaptive energy sources can be saved.

Optionally, all the transfer tanks are disposed on a same fixing plate, which is convenient for installation and maintenance. Further, all the transfer tanks are uniformly fixed on a fixing plate, which is convenient for standardized configuration and saves cost.

Optionally, lower end surfaces of all the transfer tanks are in clearance configuration with an upper end surface of the fixing plate, and the lower end surfaces of all the transfer tanks are provided with filter ports that are disposed downward, so as to facilitate treatment of cavities of the transfer tank. Moreover, it is also easy to fix and adjust the transfer tank.

Optionally, automatic control valves are disposed at a liquid inlet and a liquid outlet of each of the transfer tanks. The automatic control valves can be automatically driven by an airflow to open or close a pipeline, so as to store solution coming from the stock solution tank via a pipeline into the transfer tank through the liquid inlet or input solution coming from the transfer tank via a pipeline to the cleaning tank through the liquid outlet.

Optionally, the liquid inlet is disposed at an upper section of a side or a top surface of the transfer groove. In order to ensure that solution in the transfer tank does not flow back into the stock solution tank during the process of injecting liquid from the stock solution tank to the transfer tank, the liquid inlet is disposed at a position near an upper end surface of a side or a top surface of the transfer tank. Further, the liquid outlets in all the transfer tanks are located at one end of near the lower end surface of a side of the transfer tank, so as to facilitate the overflow and circulation of the solution from the transfer tank through the liquid outlets, and avoid the phenomenon that liquid in the tank cannot be discharged due to the high position of the liquid outlets. Meanwhile, since the liquid outlet and its automatic control valve are common accessories, they are required to be disposed on a side wall of the transfer tank for case of installation and maintenance, which are convenient to operate as well.

Optionally, the liquid inlet and the liquid outlet in a same transfer tank are disposed on a same side or on a side and a top surface that are adjacent. That is to say, for the same transfer tank, the liquid inlet and the liquid outlet are located at a lower section and an upper section of the same side respectively; or the liquid outlet is located at a lower section of a side and the liquid inlet is located at the top, and the side is adjacent to the top. Meanwhile, the positions of the liquid inlets in all the transfer tanks are disposed on the same side at the same height. This structure has good uniformity and is easy to manage and disassemble.

Optionally, each of the transfer tanks is further equipped with a liquid level tube, and the liquid level tube is disposed on an outer wall of the transfer tank. The liquid level tube can be used to monitor the height of the solution in the transfer tank. Optionally, the liquid level tube is a transparent glass tube or hose, which is convenient for visual observation of the liquid level height of the solution.

A side on which the liquid level tube is located is opposite to a side on which the liquid inlet is located in a same transfer tank, and the liquid level tubes of all the transfer tanks are disposed on the same side. That is to say, since the adjacent transfer tanks are close to each other or disposed at intervals, the liquid level tube of the transfer tank in the middle position can only be disposed on its back side, that is, opposite to the side where the liquid inlet is located. Furhter, in order to facilitate installation and maintenance, it is required that the liquid level tube of the transfer tank in the non-intermediate position is also located on the opposite side of the liquid inlet. That is to say, all the liquid level tubes are disposed on the same side and are disposed opposite to the surface where the liquid inlets are located.

Optionally, each of the liquid level tubes is adapted to a height of the transfer tank in which it is located. In order to ensure that the liquid level tube can accurately reflect the height of the liquid level in the transfer tank, it is required that an upper port and a lower port of the liquid level tube are located at an upper end and a lower end of the side of the corresponding transfer tank, respectively.

Further, a liquid level sensor is disposed on each liquid level tube, which is used to control opening and closing of the liquid inlet in the transfer tank, so as to replenish liquid into the transfer tank. That is, when the liquid level in the transfer tank is higher than the position of the liquid level sensor, it means to close the liquid inlet and stop supplying liquid to the transfer tank. If the liquid level in the transfer tank is lower than the position of the liquid level sensor, it means that it is necessary to open the liquid inlet and continue to supply liquid to the transfer tank. For different cleaning tanks, the required amount of the solution is different, and correspondingly, the amount of the temporary solution in the transfer tank connected thereto is also different. Some cleaning tanks may be replenished more at one time, and correspondingly, the amount of the solution that replenished into the transfer tank from the stock solution tank is also more, which is referred to as a large liquid replenishment method. Some cleaning tanks may be replenished relatively less at one time, and correspondingly, the amount of the solution that replenished into the transfer tank from the stock solution tank is also less, which is referred to as a small liquid replenishment method. Therefore, the height of the liquid level sensor in each transfer tank is different.

Optionally, the stock solution unit further includes a water source tank disposed in direct communication with each of the cleaning tanks. Solutions in the stock solution tank and the transfer tank are solutes of the chemical solution. Since the solvent in the cleaning tank is water, and water is pollution-free and odorless and is a pure resource, each cleaning tank can be directly connected with the water source tank, and water can be directly injected into each cleaning tank through a water pump, which is convenient and simple.

An embodiment of the present disclosure provides a silicon wafer cleaning machine including the apparatus for supplying cleaning liquid as described above.

### BRIEF DESCRIPTION OF THE DRAWINGS

FIG. 1 is a wireframe diagram of an apparatus for supplying cleaning liquid according to an embodiment of the present disclosure.

FIG. 2 is a front perspective view of a transfer unit according to an embodiment of the present disclosure.

FIG. 3 is a rear perspective view of a transfer unit according to an embodiment of the present disclosure.

List of reference signs:

| | |
|---|---|
| 10: Stock solution unit; | 11: First stock solution tank; |
| 12: Second stock solution tank; | 13: Third stock solution tank; |
| 14: Fourth stock solution tank; | 15: Water source tank; |
| 20: Transfer unit; | 21: First transfer tank; |
| 22: Second transfer tank; | 23: Third transfer tank; |
| 24: Fourth transfer tank; | 25: Fourth transfer tank; |
| 26: Sixth transfer tank; | 27: Seventh transfer tank; |
| 28: Eighth transfer tank; | 29: Liquid inlet; |
| 210: Liquid outlet; | 211: Automatic control valve; |
| 212: Liquid level tube; | 213: Liquid level sensor; |
| 214: Fixing plate; | 30: Cleaning unit; |
| 31: First cleaning tank; | 32: Second cleaning tank; |
| 33: Third cleaning tank; | 34: Fourth cleaning tank. |

### DETAILED DESCRIPTION

The present disclosure will now be further described with reference to the accompanying drawings and some embodiments. It can be understood that the some embodiments described herein are only used to explain relevant contents, but are not intended to limit the present disclosure. In addition, for the convenience of description, only the parts related to the present disclosure are shown in the drawings.

It should be noted that the embodiments in the present disclosure and the features in the embodiments may be combined with each other without conflict. Hereinafter, the present disclosure will be described in detail with reference to the accompanying drawings and embodiments.

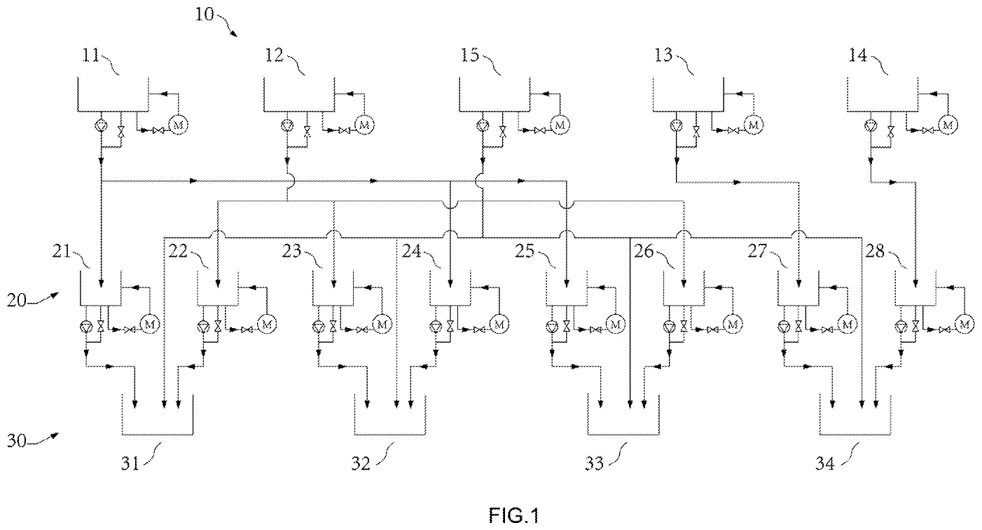

This embodiment provides an apparatus for supplying cleaning liquid, as shown in FIG. 1, which includes a stock solution unit 10, a transfer unit 20, and a cleaning unit 30, wherein the stock solution unit 10 is configured with a plurality of stock solution tanks; the cleaning unit 30 is configured with a plurality of cleaning tanks; the transfer unit 20 is disposed between the stock solution unit 10 and the cleaning unit 30, and the transfer unit 10 is configured with a plurality of independent transfer tanks. Each of the stock solution tanks communicates with at least one of the transfer tanks, each of the transfer tanks communicates with one of the cleaning tanks, and each of the cleaning tanks communicates with at least one of the transfer tanks. Both the stock solution tank and the transfer tank are used for containing solute of a medicinal solution. Each stock solution tank is connected with a plurality of transfer tanks, and each transfer tank is connected with only one cleaning tank, so as to ensure that the solute of the medicinal solution required in each cleaning tank can be input from an independent transfer tank, and the storage capacity and the output dose of the corresponding transfer tank can be set based on the characteristics of each cleaning tank, which not only achieves easily controlling of the dosage, but also has high timeliness. Further, poor consistency of the concentration of medicinal solution in the cleaning tank due to unstable air pressure in transmission pipelines caused by direct communication between the cleaning tank and the stock solution tank can be improved. Accurate and stable replenishing liquid can be achieved, the pipelines are streamlined and simple, the maintenance and installation are easy, the liquid can be supplied at any time, and the timeliness is high.

Specifically, the stock solution unit 10 is configured with four stock solution tanks, namely, a first stock solution tank 11, a second stock solution tank 12, a third stock solution tank 13, and a fourth stock solution tank 14 (when the common characteristics of these four tanks are pointed out, they are simply referred to as the stock solution tank directly, the same as below). The first stock solution tank 11 contains a cleaning agent A solution, the second stock solution tank 12 contains a cleaning agent a cleaning agent B solution, the third stock solution tank 13 contains a cleaning agent a cleaning agent C solution, and the fourth stock solution tank 14 contains a cleaning agent D solution (specific components of the cleaning agent are not within the scope of protection of the present disclosure and are omitted herein).

Further, the stock solution unit 10 further includes a water source tank 15, which is disposed in direct communication with each of the cleaning tanks. In this embodiment, only one water source tank 15 is provided. Solutions in the stock solution tank and the transfer tank are solutes of the chemical solutions. Since the solvent in the cleaning tank is water, and water is pollution-free and odorless and is a pure resource, each cleaning tank can be directly connected with the water source tank 15, and water can be directly injected into each cleaning tank through a water pump, which is convenient and simple

The transfer unit 20 includes eight transfer tanks, namely, a first transfer tank 21, a second transfer tank 22, a third transfer tank 23, a fourth transfer tank 24, a fifth transfer tank 25, a sixth transfer tank 26, a seventh transfer tank 27, and a eighth transfer tank 28. The first transfer tank 21, the fourth transfer tank 24 and the fifth transfer tank 25 are all communicated with the first stock solution tank 11, that is, the cleaning agent A solution is temporarily stored in the first transfer tank 21, the fourth transfer tank 24 and the fifth transfer tank 25. In other words, the first stock solution tank 11 communicates with three transfer tanks. The second transfer tank 22, the third transfer tank 23, and the sixth transfer tank 26 are all communicated with the second stock solution tank 12, and the cleaning agent B solution is temporarily stored therein. That is, the second transfer tank 22 communicates with three transfer tanks. The seventh transfer tank 27 communicates directly with the third stock solution tank 13, and the cleaning agent C solution is temporarily stored therein. The eighth transfer tank 28 communicates directly with the fourth stock solution tank 14, and the cleaning agent D solution is temporarily stored therein. That is, the third stock solution tank 13 and the fourth stock solution tank 14 are respectively communicated with one transfer tank.

The cleaning unit 30 is provided with four cleaning tanks, namely, a first cleaning tank 31, a second cleaning tank 32, a third cleaning tank 33, and a fourth cleaning tank 34. The first cleaning tank 31, the second cleaning tank 32, and the third cleaning tank 33 contain the same medicinal solution, that is, a mixed solution of the cleaning agent A solution, the cleaning agent B solution, and water. The proportions of the cleaning agent A solution and the cleaning agent B solution in the first cleaning tank 31, the second cleaning tank 32 and the third cleaning tank 33 may be the same or different, which can be determined based on actual situations, there are no specific laminations herein. The cleaning tank 4 contains an independent chemical solution, that is, a mixed solution of the cleaning agent C solution, the cleaning agent D solution and water, wherein the proportion of the cleaning agent C solution and the cleaning agent D solution is not limited. It can be further known that the first cleaning tank 31 communicates with the first transfer tank 21, the second transfer tank 22 and the water source tank 15, respectively. The second cleaning tank 32 communicates with the third transfer tank 23, and the fourth transfer tank 24 and the water source tank 15, respectively. The third cleaning tank 33 communicates with the fifth transfer tank 25, the sixth transfer tank 26 and the water source tank 15, respectively. The fourth cleaning tank 34 communicates with the seventh transfer tank 27, the eighth transfer tank 28 and the water source tank 15, respectively.

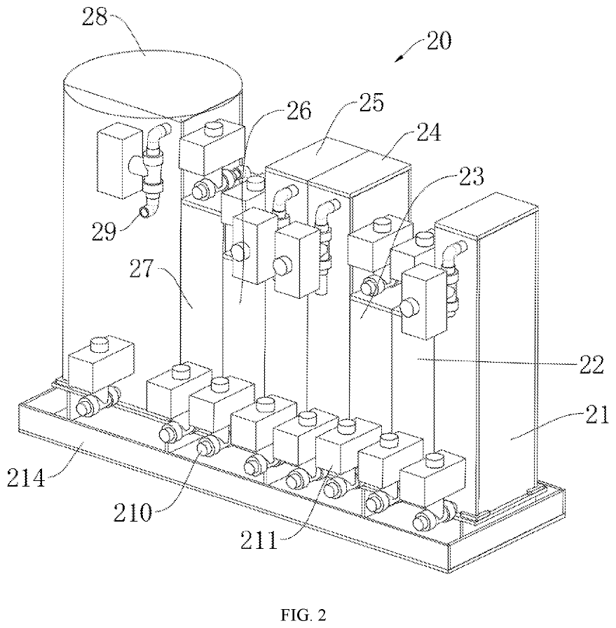

Further, as shown in FIG. 2, all the transfer tanks communicating with a same cleaning tank are disposed adjacent to each other, so that the structure is simple, and it is convenient to maintain and identify. The pipelines are simplified. Consumption of other adaptive energy sources can be saved. That is, the first transfer tank 21 and the second transfer tank 22 communicating with the first cleaning tank 31, the third transfer tank 23 and the fourth transfer tank 24 communicating with the second cleaning tank 32, the fifth transfer tank 25 and the sixth transfer tank 26 communicating with the third cleaning tank 33, and the seventh transfer tank 27 and the eighth transfer tank 28 communicating with the fourth cleaning tank 34 are all adjacently connected. Further, first transfer tank 21, the second transfer tank 22, the third transfer tank 23, the fourth transfer tank 24, the fifth transfer tank 25, the sixth transfer tank 26, the seventh transfer tank 27 and the eighth transfer tank 28 are disposed adjacently in sequence.

Optionally, all the transfer tanks are disposed on a same fixing plate 24, which is convenient for installation and maintenance. Further, all the transfer tanks are uniformly fixed on a fixing plate 24, which is convenient for standardized configuration and saves cost. In this embodiment, the fixing plate 214 has a groove structure so as to collect the solute dripping from each transfer tank and avoid polluting other places.

Optionally, lower end surfaces of all the transfer tanks are in clearance configuration with an upper end surface of the fixing plate 214, and are disposed at the same height right above the fixing plates 214. This structure is convenient for the lower end surfaces of all the transfer tanks to be provided with filter ports that are disposed downward (not shown in the figures), so as to facilitate treatment of the transfer tank cavities. Moreover, it is also easy to fix and adjust the transfer tank.

Further, each transfer tank is provided with a liquid inlet 29 and a liquid outlet 210, and automatic control valves 211 are disposed at the liquid inlet 29 and the liquid outlet 210 of each of the transfer tanks. The automatic control valves 211 can be automatically driven by an airflow to open or close a pipeline, so as to store solution coming from the stock solution tank via a pipeline into the transfer tank through the liquid inlet 29 or input the solution coming from the transfer tank via a pipeline to the cleaning tank through the liquid outlet 210.

Optionally, the liquid inlet 29 is disposed at an upper section of a side or a top surface of the transfer tank. In order to ensure that solution in the transfer tank does not flow back into the stock solution tank during the process of injecting liquid from the stock solution tank to the transfer tank, the liquid inlet 29 is disposed at a position near an upper end surface of a side or a top surface of the transfer tank. Further, the liquid outlets 210 in all the transfer tanks are located at one end of near the lower end surface of a side of the transfer tank, so as to facilitate the overflow and circulation of the solution from the transfer tank through the liquid outlets 210, and avoid the phenomenon that liquid in the tank cannot be discharged due to the high position of the liquid outlets 210. Meanwhile, since the liquid outlet 210 and its automatic control valve are common accessories, they are required to be disposed on a side wall of the transfer tank for case of installation and maintenance, which are convenient to operate as well.

Optionally, the liquid inlet 29 and the liquid outlet 210 in a same transfer tank are disposed on a same side or on a side and a top surface that are adjacent. That is to say, for the same transfer tank, the liquid inlet 29 and the liquid outlet 210 are located at a lower section and an upper section of the same side respectively; or the liquid outlet 210 is located at a lower section of a side and the liquid inlet 29 is located at the top, and the side is adjacent to the top. Meanwhile, the positions of the liquid inlets 29 in all the transfer tanks are disposed on the same side at the same height. This structure has good uniformity and is easy to manage and disassemble.

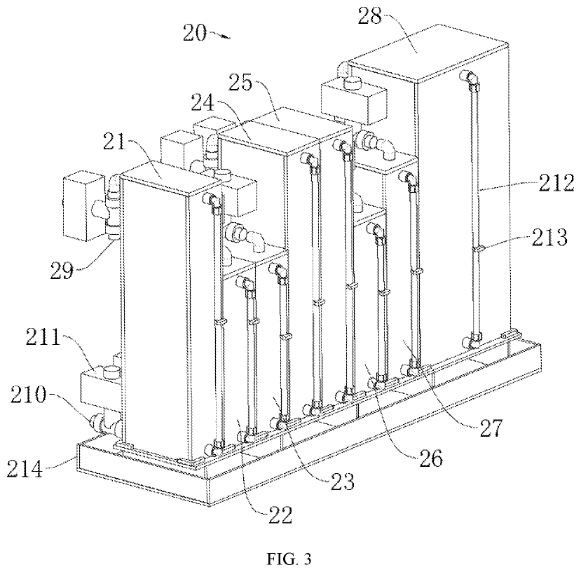

Further, as shown in FIG. 3, each of the transfer tanks is further configured with a liquid level tube 212, and the liquid level tube 212 is disposed on an outer wall of the transfer tank. The liquid level tube 212 can be used to monitor the height of the solution in the transfer tank. Optionally, the liquid level tube 212 is a transparent glass tube or hose, which is convenient for visual observation of the liquid level height of the solution.

A side on which the liquid level tube 212 is located is opposite to a side on which the liquid inlet 29 is located in a same transfer tank, and the liquid level tubes 212 in all the transfer tanks are disposed on the same side. That is to say, since the adjacent transfer tanks are close to each other or disposed at intervals, the liquid level tube 212 of the transfer tank in the middle position can only be disposed on its back side, that is, opposite to the side where the liquid inlet 29 is located. Furhter, in order to facilitate installation and maintenance, it is required that the liquid level tube 212 of the transfer tank in the non-intermediate position is also located on the opposite side of the liquid inlet 29. That is to say, all the liquid level tubes 212 are disposed on the same side and are disposed opposite to the surface where the liquid inlets 29 are located.

Further, each of the liquid level tubes 22 is adapted to a height of the transfer tank in which it is located. In order to ensure that the liquid level tube 212 can accurately reflect the height of the liquid level in the transfer tank, it is required that an upper port and a lower port of the liquid level tube 212 are located at an upper end and a lower end of the side of the corresponding transfer tank, respectively.

Further, a liquid level sensor 213 is disposed on each liquid level tube 212, which is used to control opening and closing of the liquid inlet 29 in the transfer tank, so as to replenish liquid into the transfer tank. That is, when the liquid level in the transfer tank is higher than the position of the liquid level sensor 213, it means to close the liquid inlet 29 and stop supplying liquid to the transfer tank. If the liquid level in the transfer tank is lower than the position of the liquid level sensor 213, it means that it is necessary to open the liquid inlet and continue to supply liquid to the transfer tank. For different cleaning tanks, the required amount of the solution is different, and correspondingly, the amount of the temporary solution in the transfer tank connected thereto is also different. Some cleaning tanks may be replenished more at one time, and correspondingly, the amount of the solution that replenished into the transfer tank from the stock solution tank is also more, which is referred to as a large liquid replenishment method. Some cleaning tanks may be replenished relatively less at one time, and correspondingly, the amount of the solution that replenished into the transfer tank from the stock solution tank is also less, which is referred to as a small liquid replenishment method. Therefore, the height of the liquid level sensor 213 in each transfer tank is different.

A silicon wafer cleaning machine, which adopt the apparatuses for supplying cleaning liquid as described above.

According to the apparatus for supplying cleaning liquid and the silicon wafer cleaning machine adopting said apparatus for supplying cleaning liquid provided in the present disclosure, a transfer unit for automatically supplying liquid is disposed between the stock solution unit and the cleaning machine. The transfer unit includes a plurality of independent transfer tanks, which contain the solute of chemical solution coming from each stock solution tank. The solute of chemical solution in the whole transfer unit can automatically stored and imported into the cleaning tank, which ensures that all cleaning liquids in the cleaning tank are ready-to-use and new, and the timeliness is higher, thus ensuring the consistency of the concentration of each cleaning liquid, and ensuring the safety of liquid supply in the whole apparatus and high efficiency of liquid supply.

Some embodiments of the present disclosure have been described in detail above, but are not intended to limit the scope of the present disclosure. All equivalent changes or modifications made in accordance with the present disclosure shall fall within the scope of the present disclosure.

What is claimed is:

1. An apparatus for supplying cleaning liquid, comprising:
a stock solution unit configured with a plurality of stock solution tanks;
a cleaning unit configured with a plurality of cleaning tanks; and
a transfer unit disposed between the stock solution unit and the cleaning unit and configured with a plurality of transfer tanks independently arranged,
wherein each of the stock solution tanks communicates with at least one of the transfer tanks, each of the transfer tanks communicates with one of the cleaning tanks, and each of the cleaning tanks communicates with at least one of the transfer tanks.

2. The apparatus according to claim 1, wherein all ones of the transfer tanks communicating with a same one of the cleaning tanks are disposed adjacently.

3. The apparatus according to claim 1, wherein all the transfer tanks are disposed on a same fixing plate.

4. The apparatus according to claim 3, wherein a lower end surface of each of the transfer tanks is spaced from an upper end surface of the fixing plate.

5. The apparatus according to claim 1, wherein an automatic control valve is disposed at each of a liquid inlet and a liquid outlet of each of the transfer tanks.

6. The apparatus according to claim 5, wherein the liquid inlet is disposed at an upper section of a side or a top surface of a corresponding one of the transfer tanks.

7. The apparatus according to claim 6, wherein the liquid inlet and the liquid outlet of a same one of the transfer tanks are disposed on a same side or respectively on a side and a top surface that are adjacent.

8. The apparatus according to claim 6, wherein each transfer tank of the transfer tanks is further configured with a liquid level tube, and the liquid level tube is disposed on an outer wall of the transfer tank;
a side on which the liquid level tube is located is opposite to a side on which the liquid inlet of the transfer tank is located; and
the liquid level tube of each of the transfer tanks is disposed on a same side.

9. The apparatus according to claim 8, wherein the liquid level tube is adapted to a height of the transfer tank on which the liquid level tube is located; and
a liquid level sensor is disposed on the liquid level tube.

10. The apparatus according to claim 1, wherein the stock solution unit further comprises a water source tank directly communicating with each of the cleaning tanks.

11. The apparatus according to claim 2, wherein all the transfer tanks are disposed on a same fixing plate.

12. The apparatus according to claim 2, wherein an automatic control valve is disposed at each of a liquid inlet and a liquid outlet of each of the transfer tanks.

13. The apparatus according to claim 4, wherein an automatic control valve is disposed at each of a liquid inlet and a liquid outlet of each of the transfer tanks.

14. The apparatus according to claim 7, wherein each transfer tank of the transfer tanks is further configured with a liquid level tube, and the liquid level tube is disposed on an outer wall of the transfer tank;
a side on which the liquid level tube is located is opposite to a side on which the liquid inlet of the transfer tank is located; and
the liquid level tube of each of the transfer tanks is disposed on a same side.

15. The apparatus according to claim 2, wherein the stock solution unit further comprises a water source tank directly communicating with each of the cleaning tanks.

16. The apparatus according to claim 4, wherein the stock solution unit further comprises a water source tank directly communicating with each of the cleaning tanks.

17. The apparatus according to claim 6, wherein the stock solution unit further comprises a water source tank directly communicating with each of the cleaning tanks.

18. The apparatus according to claim 7, wherein the stock solution unit further comprises a water source tank directly communicating with each of the cleaning tanks.

19. The apparatus according to claim 9, wherein the stock solution unit further comprises a water source tank directly communicating with each of the cleaning tanks.

20. A silicon wafer cleaning machine including the apparatus for supplying cleaning liquid according to claim 1.
